(19) United States
(12) Patent Application Publication
(10) Pub. No.: US 2007/0155194 A1
(43) Pub. Date: Jul. 5, 2007

(54) System for the mechanical and electrical connection of printed circuits

(76) Inventor: Aurelio Vega Martinez, Las Palmas De Gran Canaria (ES)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/558,311

(22) PCT Filed: May 20, 2003
(86) PCT No.: PCT/ES03/00227

§ 371 Date: Oct. 6, 2006

(51) Int. Cl. H01R 12/00

(52) U.S. Cl. 439/62

(57) ABSTRACT

The invention relates to a system for the mechanical and electrical connection of printed circuit modules. According to the invention, the corresponding module is produced with a series of tongues (1) which are distributed uniformly around the edge thereof and which comprise two symmetrical sections (1a and 1b). Moreover, the configuration of the tongues (1) is identical and symmetrical to the space defined therebetween, such as to enable the corresponding intercoupling of modules. In this way, the modules (7) are connected mechanically and electrically by means of the contact formed by the lateral metallized surface of the tongues and both the upper and lower surfaces of the modules. Asymmetric tongues (2) are disposed at the corners, comprising a single section which is positioned perpendicularly to one of the sections of the adjacent, symmetrical tongue (1). The aforementioned tongues (1 and 2) can be used easily and simply to interconnect modules, by moving one module vertically in relation to the other, without the need for external connectors.

### FIELD OF INVENTION

The present invention relates to a system for the mechanical and electrical connection of printed circuit boards based on tongues which are distributed uniformly around the edge of the modules or printed circuit pieces which are to be intercoupled. The electrical connection of the signals between the modules or printed circuit pieces is guaranteed by means of the contact formed by the lateral metallized surface of the tongues.

The tongues have a special shape to guarantee the perfect intercoupling between printed circuit modules, so that a unique force applied perpendicularly to the surface is required. Moreover, the particular placement of the tongues along the module edge enables multiple intercoupling positions.

By using the intercoupling connection system of the present invention a fast and safe assembly of printed circuits is enabled, and there is no need for external connectors so a noticeable saving is achieved in the cost of the joint, the weight of the final block and the overall surface used to make the connection.

### BACKGROUND OF THE INVENTION

A wide variety of connection systems used in electronic equipments to link printed circuit pieces mechanical and electrically are well known. In the case of lateral assembly of printed circuits, the connection is achieved typically by means of a connector soldered on each of the pieces to make the link. Once both parts of the connector have mated, the joint will enable the block to electrically interconnect the required signals and to improve its mechanical rigidity.

In other words, the traditional methods to connect printed circuits are based on the soldering of a male and the corresponding female connector on the printed circuit pieces to interconnect. The mechanical and electrical interconnection is achieved by the insertion of the female connector into the male one using a relatively low force.

By using the above-mentioned connectors in the electronic equipment designs, the electronic modules can be plugged and unplugged in an easy and smart way, but at the extra cost of the connectors.

### SUMMARY OF THE INVENTION

The proposed system has been conceived to drastically reduce the amount of the substrate which is required for the joint, together with the reduction of the electronic system final cost after removing the external connectors.

To be more precise, the system of the invention is characterized by the printed circuit module having multiple tongues all around its perimeter so that a drastic reduction of the needed printed circuit area for interconnection is achieved, since the interconnecting tongues enable not only the mechanical intercoupling of printed circuit modules but also the electrical interconnection of these.

The final module height plus the connection in the interconnecting points is exactly the same as the used substrate, so this is specially suitable for those, electronic systems with severe space restrictions.

The interconnecting tongues have two different configurations, one of them (a side tongue) symmetrical and the other one (an end tongue) asymmetrical. The symmetrical tongues have two or more metallized sections for the electric contact distributed along the contour of the tongue and separated by dielectric material.

The edge or lateral contact surface between tongues can be perpendicular to the module surface all around or just in a limited section. In the latter case, it makes possible a connection by wedging one module into the other.

If the lateral contact surface of the tongue is perpendicular to the module surface all around, some stops can be defined on both the upper and lower planes of the module to avoid the misalignment of the interconnected modules with respect to their reference position. In any case, the perpendicular movement of the modules can be avoided by adding solder at the outer metallic areas on the contact points between the modules.

The required force to make the perpendicular insertion of the modules can be adjusted during the manufacturing process by modifying the gaps of the mechanized edge of the printed circuit, that is, the shape of the tongues.

According to the system of the invention, the shape of the connection is the same for every printed circuit to connect, as opposed to the traditional solution using male and female connectors.

The symmetrical side tongues are formed by two halves or symmetrical sections with respect to their center axis, being their conductive metallic surfaces isolated electrically by a dielectric material. On the other hand, the asymmetrical end tongues have only one half and they are located at the corners.

The modules using the system of the invention have their conductive surfaces extended to other respective conductive areas corresponding to annular rings around small holes where test probes can be used to verify the electrical signal reaching the tongue.

Another novel characteristic featured by the system of the invention relates to the fact that the sides where the electric contact areas of the tongues are located can be perpendicular to the module surface in all their extent or just in some sections where a path which is oblique to the module surface is also present. If this is the case, the intercoupling will be by a wedging action.

Some stops on the upper and lower planes of the modules have been provided to avoid misalignment of these modules when intercoupling.

In a different implementation, the lateral contact surface of the tongues will not be metallized so that the electrical connection will be achieved by surface soldering of the mated tongues.

Another featured characteristic relates to the ability of the rectangular configured modules to have slots running from the center towards one side. These slots would have contact points in one or both of their sides allowing to get a tridimensional structure with four connection media forming 90° angles.

Finally, it can be stated that the mechanical and electrical joint of two printed circuit modules can be carried out by using identical mechanized pieces which allows for the interconnection without solder by just pressing them into mated relation.

### BRIEF DESCRIPTION OF THE DRAWINGS

To complete the description undergoing and in order to help a better understanding of the characteristics of the invention, according to an example of a practical implementation, a set of drawings has been included as an integral part of the description and with a clarifying but not limiting purpose. The presented items follow:

FIG. 1 shows a floor view of a printed circuit module corner with the mechanical and electrical connection system carried out according to the present invention. In this figure the inner contact surfaces of the tongues have an angle a with respect to the horizontal longitudinal perimeter of the module.

FIG. 2 shows a view like the previous figure, although in this case the angle a formed by the inner contact surface of the tongues is 0°.

FIG. 3 shows a view according to a general perspective of what is presented in FIG. 2.

FIG. 4 shows a plan view of a generic printed circuit module having the connection tongues around its perimeter, and with central portions broken away.

FIG. 5 shows a plan view of four printed circuit modules interconnected in a regular shape and with a small square space among them, that is, in the center of the interconnection set.

FIG. 6 shows another view of an interconnection, in this case these are three printed circuit modules forming a ‘T’ connection.

FIGS. 7a and 7b show two plan views of two implementation ways of the connection system of the present invention, together with the intercoupling tongues showing their symmetrical sections.

FIGS. 8a and 8b show in the upper parts, two plan views of a joint of printed circuit modules, one with metallized edges and one with non-metallized edges, and in the lower parts sectional views taken on the broken lines in the upper parts.

FIGS. 9a and 9b show two plan views corresponding to another way of connection with four contact sections by tongue.

FIGS. 10a and 10b are similar to FIGS. 8a and 8b and show two connection systems where it can be seen the surface soldering on printed circuits with non-metallized edges, with two or four contact sections by tongue.

FIGS. 11a and 11b show contact sections forming the corners with two and four contact sections respectively.

FIG. 12 shows a plan view of a printed circuit module with a connection system prepared on the upper and lower edge of the border.

FIGS. 13a and 13b show plan and sectional views of the joint of two printed circuit modules in a way that permit the building of a tridimensional circuit with four connection media, and whose modules form 90° angles.

FIG. 14 is a view similar to FIG. 8a with the components separated, showing a way of mechanical and electrical connection according to a different embodiment.

FIG. 15 is a sectional view which shows the connections made when the interconnection of the components has been carried out as shown in FIG. 14.

### DETAILED DESCRIPTION OF THE PREFERRED EMBODIMENTS

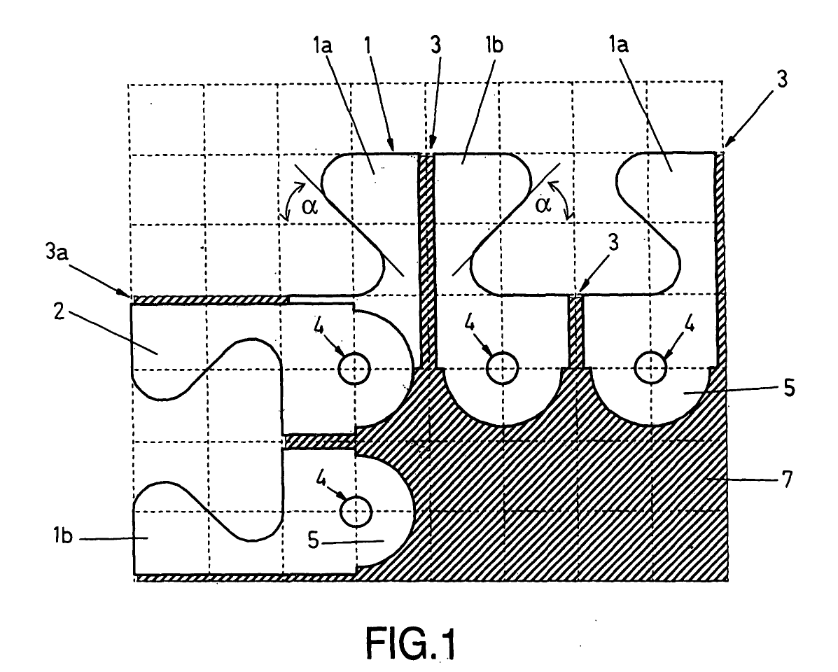

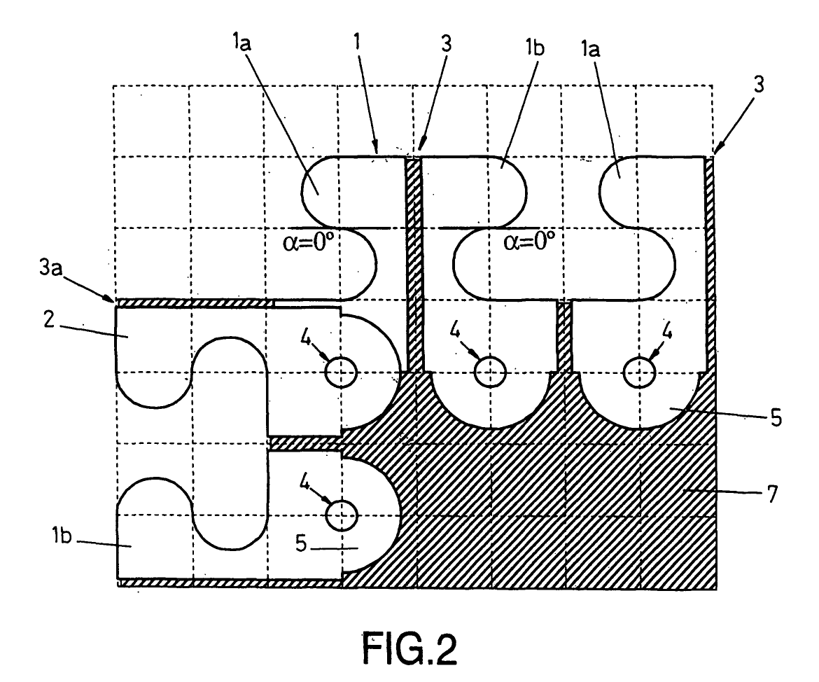

As it is possible to see in FIGS. 1 and 2, the corner corresponding to the printed circuit module with the connection system object of the invention, displays a quadrangular reticule or network over which the corner of that module has been drawn accurately, and in which the grids have equal width and length.

As it can be observed, the printed circuit module (7) incorporates a plurality of regularly distributed side tongues (1), with a special geometry that allows linking of two similar modules by means of a vertical displacement of them. Each side tongue (1) has two symmetrical halves or sections (1a) and (1b), so that the existing space between a section (1a) or (1b) and the section corresponding to the contiguous adjacent tongue corresponds to a space of equal configuration to the one tongue (1), with the object of allowing the interconnection between printed circuit modules (7). The separation between the axes of two adjacent tongues (1) is double the distance between the outer edge and the inner edge of the same.

As for the cut of module (7), in the determination of sections (1a) and (1b) of each tongue (1), it forms in its midpoint a certain angle a with the horizontal which is variable between 0° and 90°, as shown in FIG. 1 for angle α=45° and in FIG. 2 for α=0°.

Besides, the corners of the tongues (1) are rounded off with a degree of curvature certain and equal in all of them, uniting this degree of curvature the outer contour of the tongue.

Each one of sections (1a) and (1b) are metallized in their surface and in the zone of perpendicular cut (6a) and (6b), so that metallized surfaces of sections (1a) and (1b) of each tongue (1) are isolated electrically between them by a zone of electrical isolation (3) with a determined width, whereas the electrically conductive zone of each tongue section extends to match with a metallized crown (5) established around the hole (4) that is next, being such holes provided to allow the insertion of a test-probe for the verification of the electrical signal that reaches the connection tongue, although the use of the verification system is not essential.

Further, in addition to the symmetrical side tongues (1), in each one of the corners of the module (7) an end tongue of asymmetrical connection (2) is provided that has a single section, and is located in a way such that it forms an angle of 90° with the symmetrical tongue of the left of the upper edge of the printed circuit, as shown in FIGS. 1 and 2. In this case, the hole or drill (4) associated to the symmetrical tongue (2) is common to the section (1a) of the contiguous tongue (1).

Sections (1a) and (1b) of all symmetrical tongues (1) are metallized on both sides of the printed circuit module (7).

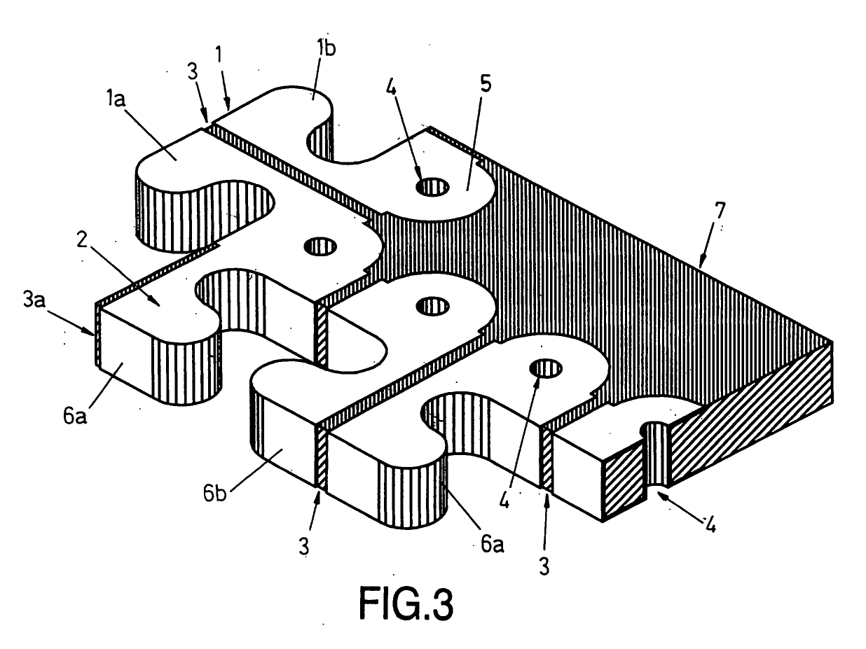

Coming to FIG. 3, the same corner of module (7) shown in FIGS. 1 and 2 is seen here in perspective, so that the zones of lateral contact (6a) and (6b) that span between the upper and lower surfaces and electrically link the upper and lower surfaces of the module (7) can be shown.

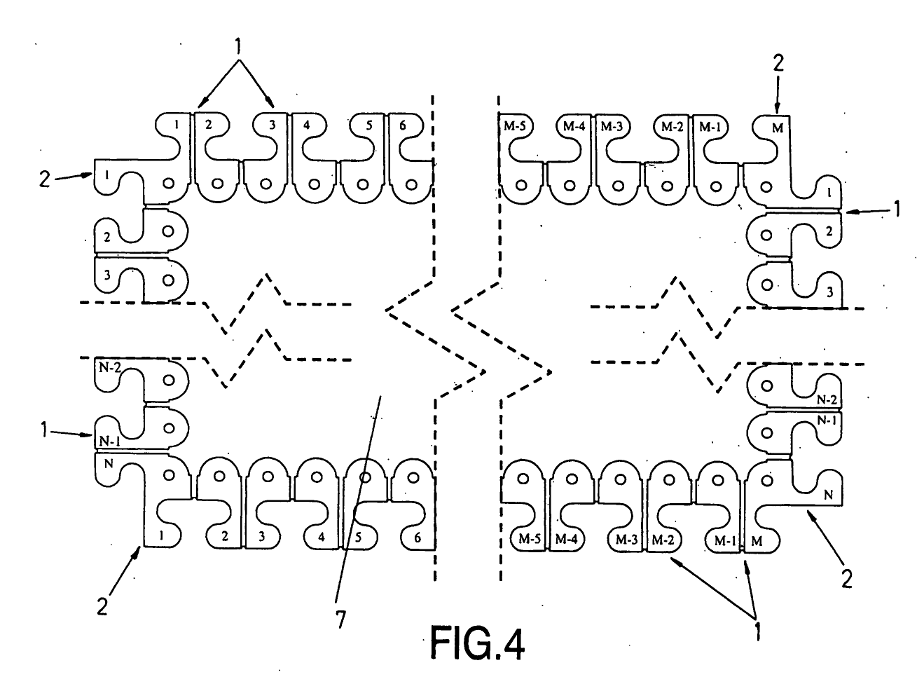

FIG. 4 corresponds to a plan view of a printed circuit module (7) that all along its perimeter includes side tongues of connection (1), as well as those connection end tongues (2) corresponding to the corners, so that the regular and equidistant distribution of M tongues of connection on the upper and lower sides of the module (7) and on N lateral tongues on left and right sides of same module (7), being able to also verify that each one of the four sides has an uneven number of sections of connection tongues, numbered in a correlative way from left to right, on upper and lower surfaces, and from up to down on left and right sides.

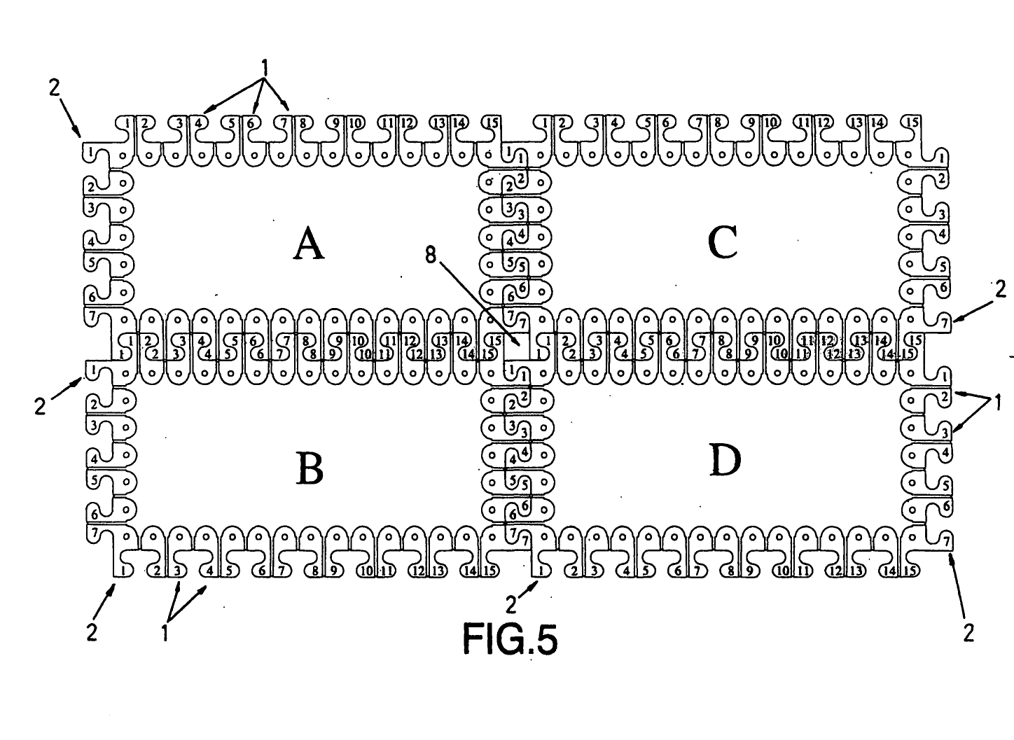

In FIG. 5 the assembly of four modules of circuit printed A, B, C, and D, incorporated to the system of interconnection of the present invention throughout all its perimeter is observed, with a relation of 7×15 contacts, properly numbered in the tongues. In FIG. 5 it can be observed that module A has connected its 15 contacts of the lower edge with the 15 contacts of the upper edge of module B. In a similar way module A has made connections between the 7 contacts of the right side and the corresponding contacts of the left side of module C. Modules C and B are connected to each other in an analogous way to the A-B modules, showing this FIG. 5 a multiple contact between all the located elements of connection in the four corners with a central hole (8).

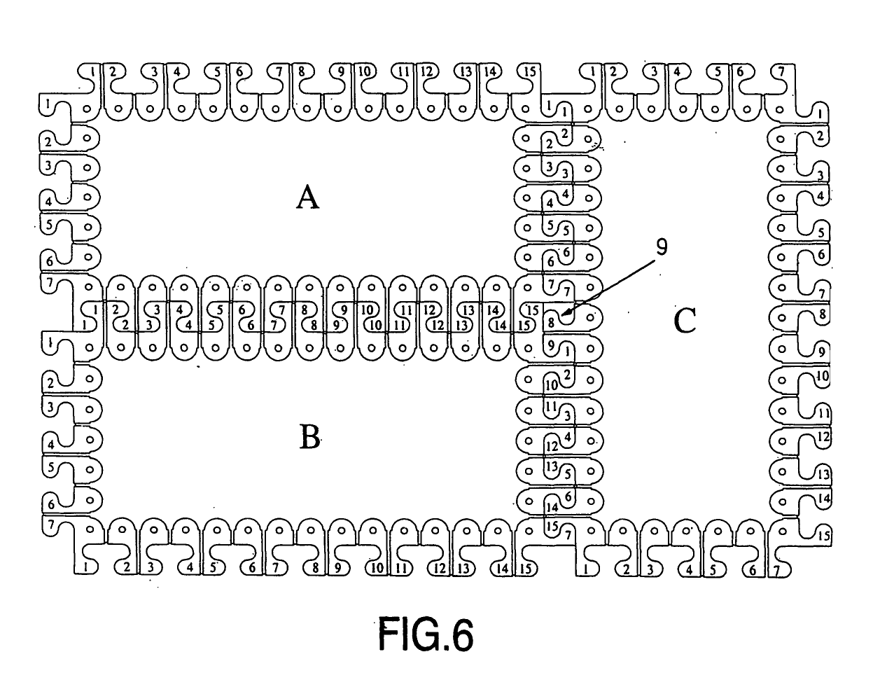

In FIG. 6 it is shown the assembly, in a different position, of three modules A, B, and C in a way such that the module A with fifteen contacts is connected to the fifteen contacts of the upper edge of the module B, placed immediately below. In a similar way, the modules A-B are connected to the module C that is placed at the right of them, being able to verify that the contact referred with number (9) corresponding to the module C is disconnected from module A, but is connected to module B.

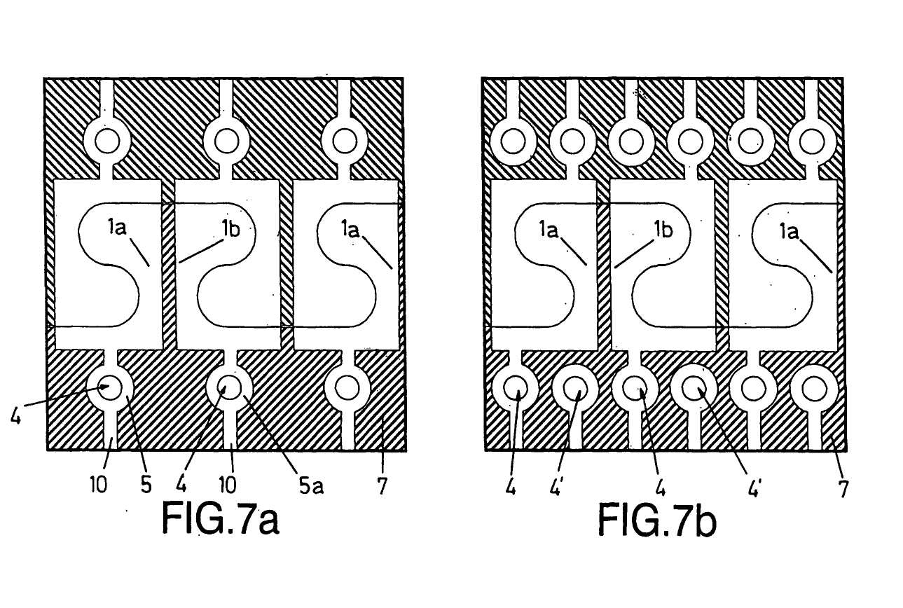

In FIG. 7a it is shown the union of two modules (7), with the symmetrical sections (1a) and (1b) in the upper and lower surfaces connected electrically through the metallized holes (4), showing that the areas (5,5a) corresponding to the holes or drills (4) are separated from the edge of the metallized zone of the sections (1a) and (1b). In this embodiment of the FIG. 7a, the number of electrical connections between the printed circuit modules interconnected, is of two electrical connections by tongue. It can be seen in FIG. 7a the tracks (10) to set up the interconnection with the lower tongues.

In the FIG. 7b it is shown a variation of the embodiment of the connection system represented in the FIG. 7a, including in addition to the holes (4), other new holes (4′) in a way such that in this case the holes (4) and (4′) are electrically isolated between them, being able to see that in this case the number of electrical connections between the interconnected printed circuits is four electrical connections per tongue.

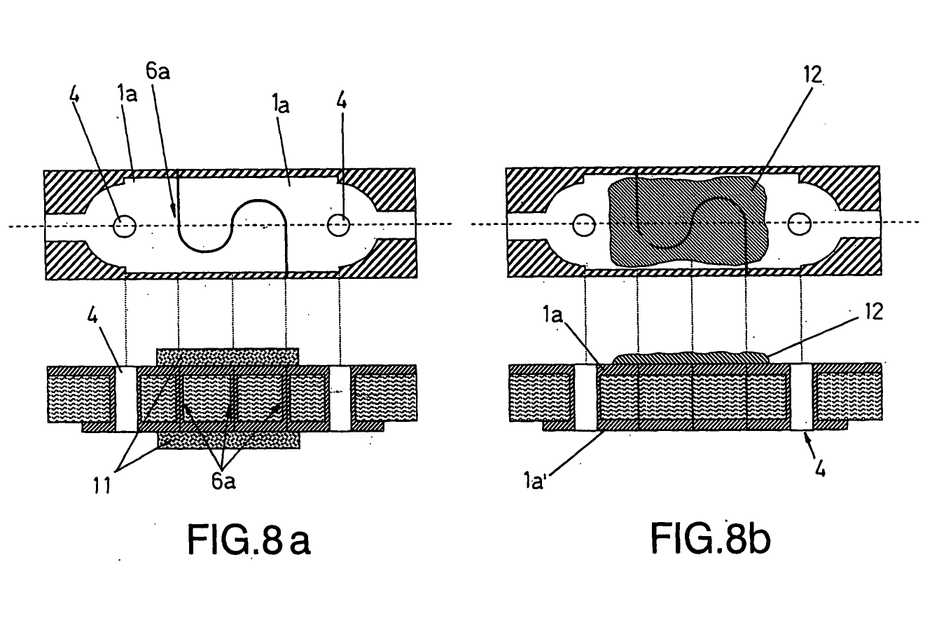

In the FIG. 8a it is shown a plan view and a sectional view of the union of two symmetrical sections (1a) corresponding to two tongues (1), in a way such that in this case the contour (6a) of the tongues is metallized and hence electrical contact exists through this area, between the sections of the upper surface and the lower surface of the printed circuit module.

Furthermore, the contacts are metallized too, so that the electrical union between the upper and lower surface is made simultaneously in several contact points, in a way such that to avoid that a printed circuit module could shift vertically with respect to another, is possible to use different materials (11) on both surfaces, that could act as stops, in a way such that in case of dovetail joint made by wedging will only require one stop. In this FIG. 8a the holes (4) can be seen.

In the FIG. 8b it is presented the same union shown in the FIG. 8a, with the difference that there is no metallization on the contour, in a way such that the only electrical contact between the sections of the upper and lower surface is produced through the holes (4). In this case, to avoid the shifting of the printed circuit modules interconnected, with respect to their reference position, there is a soldering material (12) in the upper surface of the module.

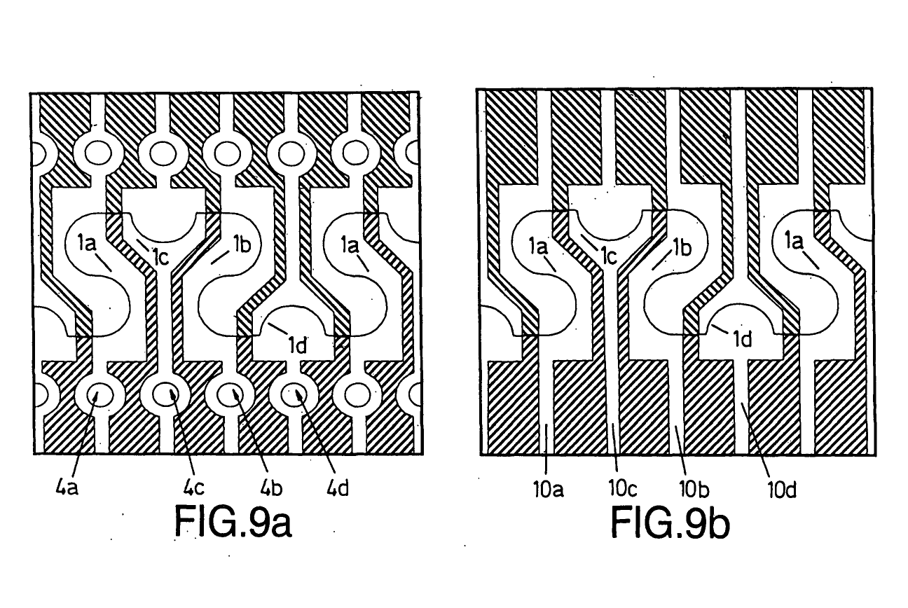

In the FIGS. 9a and 9b it is shown another alternative way of the interconnection system incorporating more than two contact sections by tongue. Specifically, in the FIG. 9a it can be seen the union of two modules that incorporate, in addition to the sections (1a) and (1b), central sections (1c) and (1d) that are placed between those, in a way such that the symmetrical sections (1a) and (1b) have changed their geometry to enable the incorporation of the section (1c) in the central area of the tongue and the section (1b) in the area that separates the adjacent tongues, being able to see that the contour of the section (1c) is not symmetrical with respect to the contour of the section (1b), being able to notice too that in this embodiment the outer contour of the tongue that joints the sections (1c) of a tongue from the section (1b) with the tongue of the module that it is connected to, it is not true, but forms a semicircle to increase the contact zone between the two modules.

In this embodiment the metallized holes (4a), (4b), (4c) and (4d) connect respectively to the sections (1a), (1b), (1c) and (1d), of the upper surface of the printed circuit module with the corresponding sections of the lower surface. In this case the number of electrical connections between the printed circuits interconnected, by means of the system of the invention, is four electrical connections by tongue.

In the FIG. 9b, the embodiment shown corresponds to a connection system of contact sections presented in the FIG. 9a, with the difference that in this new embodiment there are no metallized holes and it has not the lateral metallization. That is why the sections (1a), (1b), (1c) and (1d), of the upper surface of the printed circuit module are electrically isolated from the corresponding sections of the lower surface. The electrical connections between such sections (1a), (1b), (1c) and (1d), with the electronics that could be on the printed circuit module will be done through the conductive tracks (10a), (10b), (10c) and (10d), that is why in this case there are eight electrical connections by tongue, four of them being made between the sections of the upper surface and the other between the sections of the lower surface.

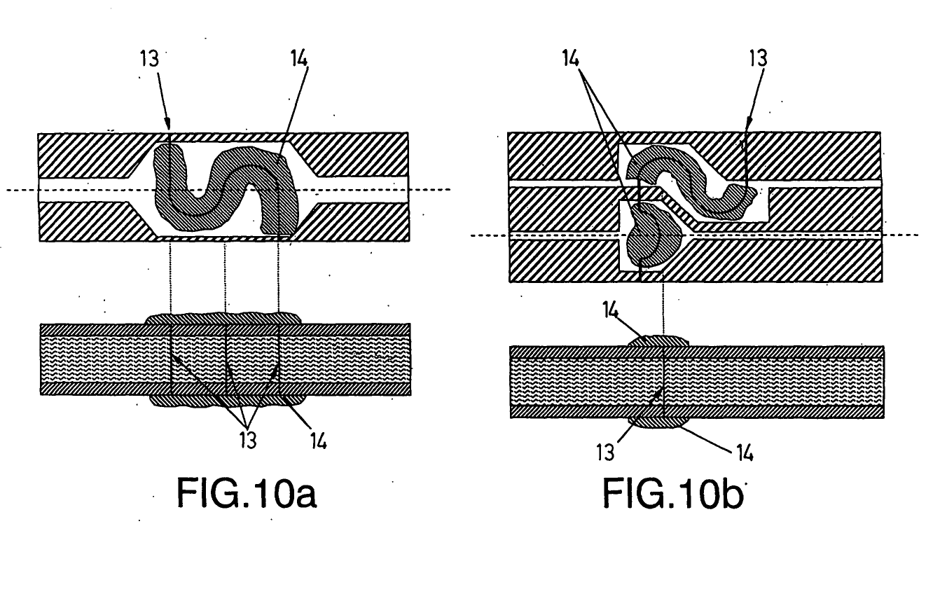

The FIGS. 10a and 10b represent the way to join printed circuit modules whose interconnection system lacks of metallized holes, having exposed edges without metallization. Specifically in the FIG. 10a it is shown the union of two symmetrical sections of a tongue, in a way such that the contact zone (13) between the printed circuit modules does not produce an electrical contact in the upper and lower surface, then the electrical connection between adjacent sections is saved in this case by means of a soldering (14).

In the FIG. 10b exist four contact sections, showing the electrical conduction by means of a soldering (14) on both surfaces of the printed circuit module.

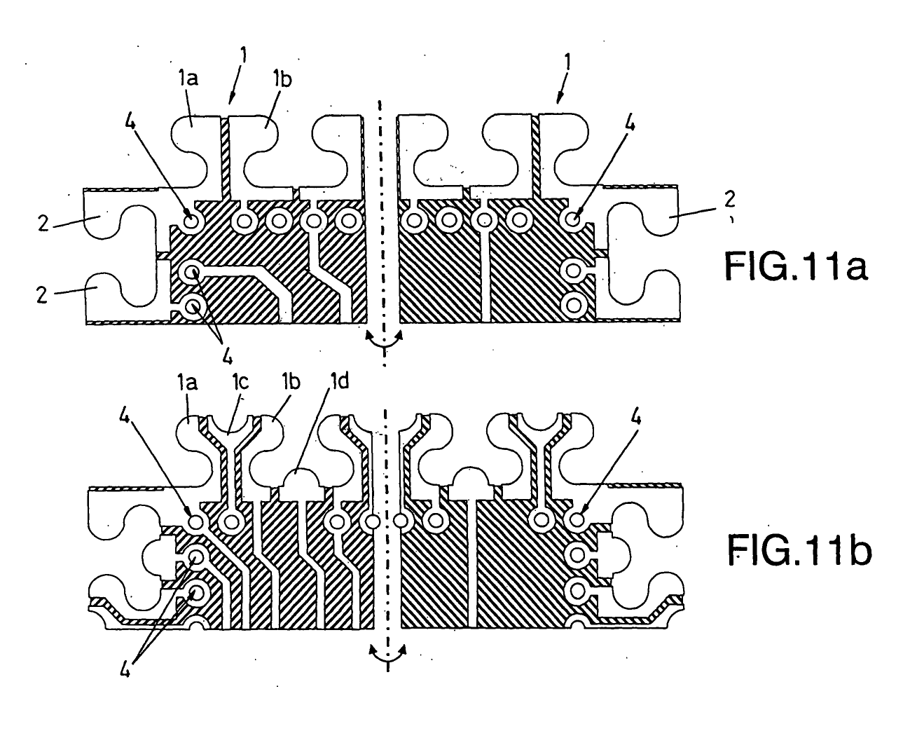

The FIG. 11 a shows an embodiment of a corner of a printed circuit module, with connection system of the invention, showing that corner from the upper side, from the left side and from the lower right side. In this embodiment, each symmetrical section incorporates two holes (4), except in the contacts that form the corner in what it is kept only one hole (4) that connects electrically the upper and lower sections of the corner contacts. In the FIG. 11b, it is shown an embodiment like the one shown in the figure. 11a, with the difference of that in this case the module tongues have four tongue sections.

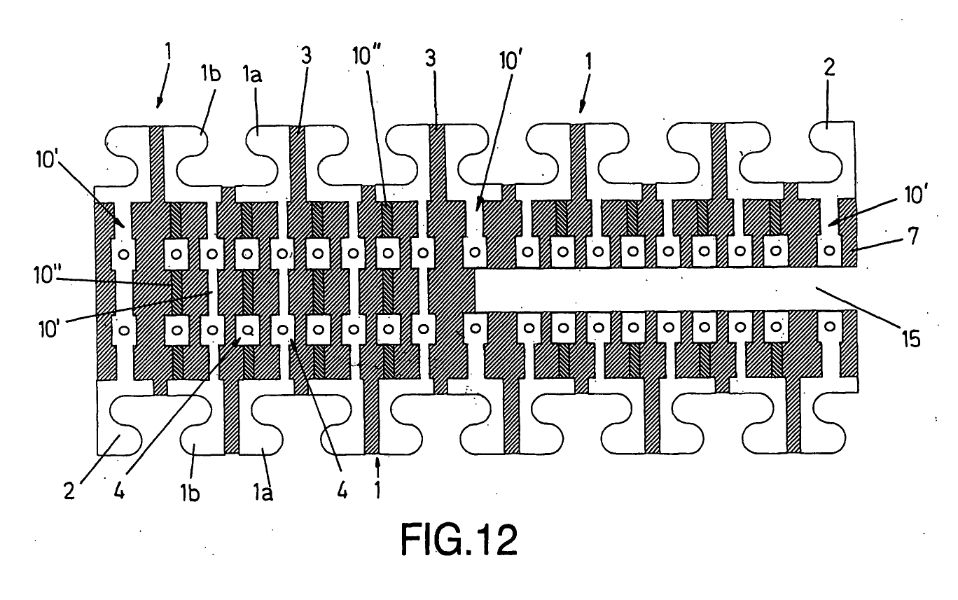

FIG. 12 shows an embodiment of a printed circuit module, that has a horizontal slot (15) that runs from the center of the module to the right edge, in a way such that the width of this slot (15) is equal to the height of the module (7) used. In this figure it can be seen that metallized holes (4) of each of the symmetrical sections (1a) and (1b) take a rectangular shape, in a way such that all the holes (4) corresponding to a connection system, are aligned horizontally and shifted as far as the edges match with the edge of the slot (15).

The sections (1a) and (1b) that can be found in the upper part are connected electrically with the corresponding sections of the tongues in the lower part, through the conductive tracks (10′) and (10″). In this embodiment the contact sections of the ends, as well as the central part, have a short-circuit between the sections of the upper and lower surfaces to transmit a better distribution of the supply signals and electrical mass, having made in this case five symmetrical tongues and one asymmetrical in each module, that is why the total number of sections is eleven, although it can be used any number of tongues if the resulting number is odd.

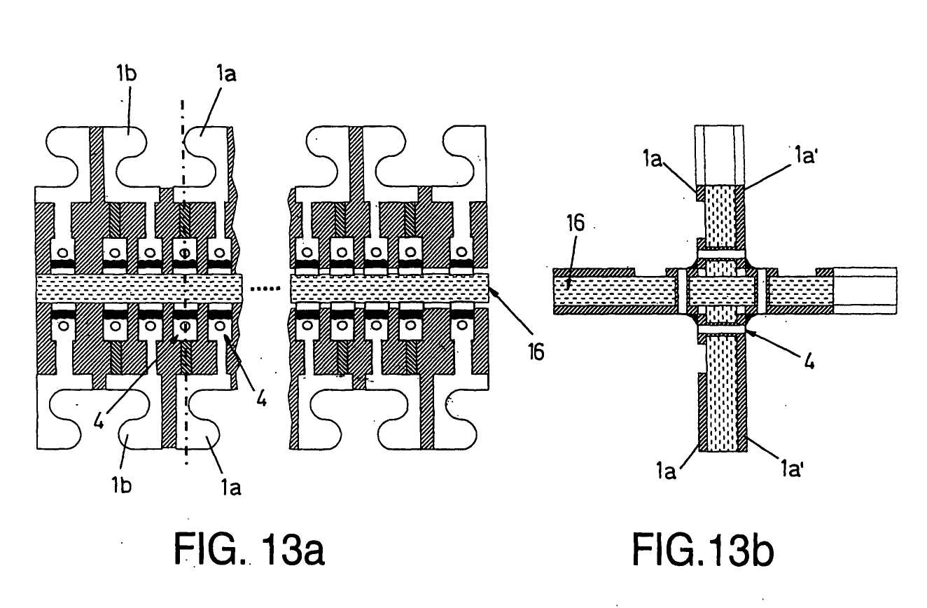

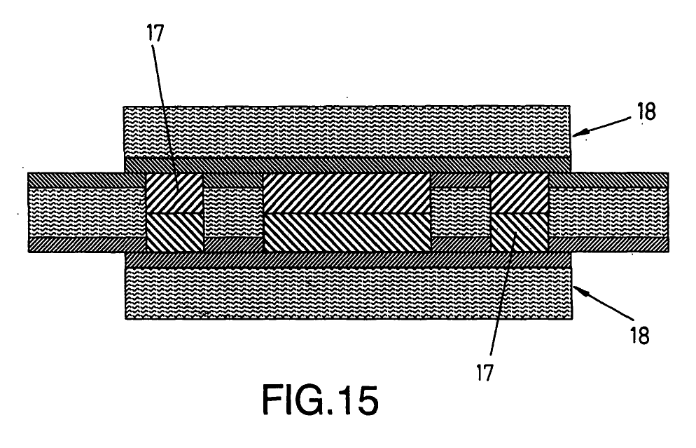

In the FIGS. 13a and 13b it is shown the assembly of two modules, producing a tridimensional assembly in what the modules form between them an angle of ninety degrees. Specifically, the FIG. 15 embodiment presents the same connection system that the FIG. 12, in what it has been sectioned it central part, in a way such that not all the tongues are visible. In this embodiment it has an added module identical to the one in the FIG. 12 but rotated one hundred and eighty degrees with respect to the vertical axis and ninety degrees with respect to the horizontal axis, in a way such that it is only noticed the edge of the module (16). In the FIG. 13b it is shown the lateral right view of a section of the FIG. 13a, made perpendicularly in the hole (4) of the left of the two shown in the FIG. 13a.

In the FIGS. 12, 13a and 13b are used connection tongues in the lower and in the upper part, although one could eliminate one of the sides keeping the holes alignment (4) that match to the eliminated side. The assembly of the printed circuit modules, like that shown in the FIG. 12, that have two tongues; with other modules that only have one tongue, would generate tridimensional assemblies with three connection tongues rotated 90° between them, in such a way that in case of using two modules with only one connection tongue it could obtain an assembly with two connection tongues rotated 90°.

It is possible to make assemblies like those shown in 13a and 13b tongues with more than two sections, although in this case it should be used with as many holes (4) as sections.

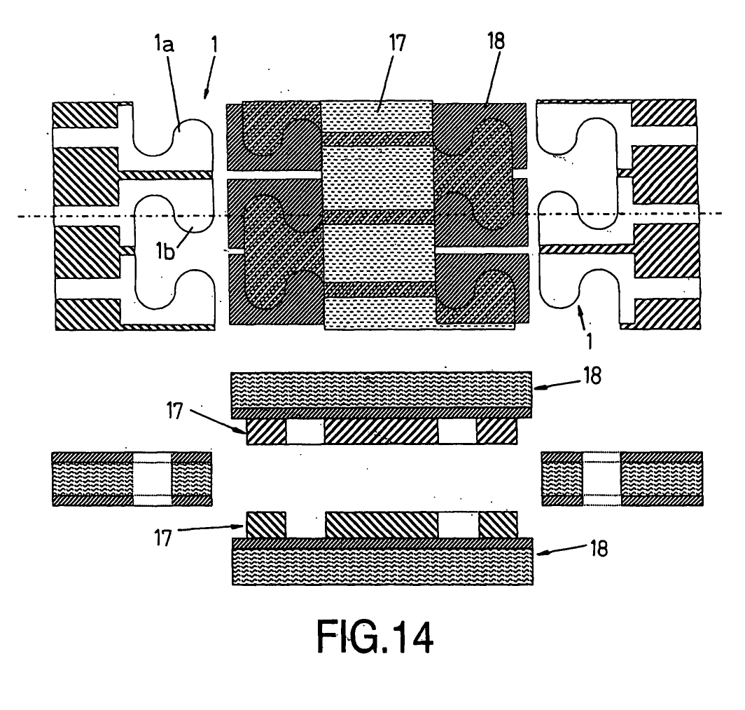

FIG. 14 shows another way to interconnect printed circuit modules that have tongues in any of their edges.

In the case that the direct connection could not be possible, or that one would not want to make soldering, the assembly shown in FIG. 14 lets one carry out the interconnection both mechanically and electrically, for which it is needed two equal parts (17), made up by a piece of dielectric material (17) and connector module (18), in a way such that the piece of dielectric material (17) will be of a thickness equal to the half of the thickness of the printed circuit module (18), with the feature that the piece of dielectric material (17) will have its contour mechanized in such away that this could fit with the tongues of the module that it is desired to connect, whereas the printed circuit connector module (18) will have on one of its faces two rectangles of conductive material joined by means of a conductive track of a variable width, in a way such that the size of the conductive rectangles will be big enough to cover the symmetrical sections (1 a) and (1 b) that could be used. In the top of the FIG. 14, it is possible to see overlapped, the piece of dielectric material (17) and the printed circuit of interconnection module (18). The piece (17) is drawn with a transparent shape to make visible the electrical contacts of the printed circuit connector module (18). The piece (17) and the printed circuit connector module (18) could be glued to avoid their shift from the reference position.

The FIG. 15 shows the final result of the assembly made based on the shown in the FIG. 14, being valid any method that could make enough force between the upper and lower circuit (18) that could avoid dismantling of the assembly. One possible solution of this mechanism may be to use a screw and a nut, that go vertically through both elements (17) and (18) in a way such that could avoid the separation.

1. System for the mechanical and electrical connection of printed circuits, featuring a plurality of tongues (1) and (2) made up on the contour of the module (7) corresponding to the printed circuit itself. These tongues (1) and (2) present a complementary configuration to the space defined between them to allow their inter-coupling by means of a vertical shift between modules. It has been planned that the tongues (1) can be determined by two halves or symmetrical sections (1a) and (1b) in relation to its central axis, and that their conductive metallic surfaces can be electrically isolated by means of an isolating dielectric material (3), whereas the tongues (2) are asymmetrical and present only one half, taking up an area corresponding to the corners.

2. System for the mechanical and electrical connection of printed circuits, according to claim 1, featured by that the lateral contact area between interconnection tongues (1) and (2), presents a central area that forms a variable angle ″″ respect to the outer perimeter of the corresponding module (7).

3. System for the mechanical and electrical connection of printed circuits, according to claim 2, featured by that the variable angle ″″ is between zero and ninety degrees.

4. System for the mechanical and electrical connection of printed circuits, according to claim 1, featured by that the interconnection tongues (1) and (2) present electrical contact zones distributed on the surface and on the lateral control (6a) and (6b) that delimits the space between adjacent tongues.

5. System for the mechanical and electrical connection of printed circuits, according to claim 1, featured by that lateral contact area or periferic to the tongues (1) and (2), is perpendicular in all its path to the main plane of the module (7) corresponding to the printed circuit.

6. System for the mechanical and electrical connection of printed circuits, according to claim 1, featured by that the lateral contact area or periferic to the tongues (1) and (2), are oblique in part of its path to the main plane of the module (7) corresponding to the printed circuit.

7. System for the mechanical and electrical connection of printed circuits, according to claim 1, featured by that the electrically conductive surface of each section (1a) and (1b) of the tongues (1) and (2), extends to match with the annular ring metallized surface (5) that is set around the holes (4), in the proximity of the corresponding section of the tongue.

8. System for the mechanical and electrical connection of printed circuits, according to claim 1, featured by that the electrical connection between the contact sections faced between the tongues (1) and (2), is made up by a surface soldering (14) between the contact sections faced between the tongues.

9. System for the mechanical and electrical connection of printed circuits, according to claim 1, featured by that both the upper plane and the lower plane of the printed circuit module (7) include stops to avoid the vertical shift of two modules interconnected respecting to their reference position.

10. System of mechanical and electrical connection of printed circuits, according to claim 1, featured by that on the upper face of the printed circuit modules it is planned a soldering material (12) to avoid the shift of two modules interconnected.

11. System for the mechanical and electrical connection of printed circuits, according to claim 1, featured by that between the symmetrical sections (1a) and (1b) of the tongues (1) are planned central sections (1c) and (1d), having planned that such sections of the upper face are connected with the corresponding of the lower face through corresponding metallized holes (4a), (4b), (4c), (4d), respectively, or through conductive tracks (10a), (10b), (10c) and (10d).

12. System for the mechanical and electrical connection of printed circuits, according to claim 1, featured by that the modules (7) incorporate interconnection tongues (1) on one or both sides, these modules being affected (7) by one horizontal slot (15) that extends from the center of the module itself (7) to one of the lateral edges free from tongues (1), enabling a tridimensional assembly, forming a ninety degrees angle between modules.

13. System for the mechanical and electrical connection of printed circuits, according to claim 1, featured by that are included two pieces of dielectric material (17) that contribute to the union of the printed circuit modules (18), equipped with tongues in any of their sides, presenting such pieces of dielectric material (17) a thickness equal to the half of the thickness of the module (18), being affected in its contour with a mechanization to fit the corresponding tongues (1); having planned that the printed circuit module (18) could present on any of its sides two rectangles of conductive material joined by means of a conductive track.
